(19) United States
(12) Patent Application Publication
(10) Pub. No.: US 2026/0105440 A1
(43) Pub. Date: Apr. 16, 2026

(54) ON-CHAIN RESOLUTION OF CONTACT INFORMATION

(71) Applicant: Unstoppable Domains Inc., Las Vegas, NV (US)

(72) Inventors: Lisa Seacat DeLuca, Bozeman, MT (US); Matthew Everett Gould, Atlanta, GA (US); Aaron Quirk, Raleigh, NC (US)

(21) Appl. No.: 18/916,593

(22) Filed: Oct. 15, 2024

(51) Int. Cl. G06Q 20/36; G06Q 20/06; G06Q 20/40

(52) U.S. Cl. CPC G06Q 20/363; G06Q 20/06; G06Q 20/4014

(57) ABSTRACT

A personal identifier of a recipient of a crypto asset to be sent from a sender is received. The personal identifier includes at least one of the following: an email address, a phone number, a driver's license number, a physical mailing address, a government assigned identifier, a school assigned identifier, or a social media account identifier. Using data stored on a blockchain, a determination is made whether a blockchain wallet address is associated with the personal identifier.

### BACKGROUND OF THE INVENTION

Traditional naming schemes are widely adopted but typically rely on centralized implementations that have multiple points of failure. These off-chain naming schemes like email address and phone number can be used to uniquely identify an individual but lack the benefits that come with blockchain technology. For example, traditional naming schemes often lack the transparency and security offered by corresponding blockchain identifiers such as blockchain wallet addresses. Unlike traditional naming schemes, blockchain solutions are commonly built using a secure and decentralized public ledger. While this offers advantages, the public and transparent nature of many blockchain solutions can conflict with the private and personal nature of an off-chain naming scheme. Therefore, there is a need for a solution that allows traditional naming schemes to be utilized with blockchain applications while preserving existing user expectations of privacy.

### BRIEF DESCRIPTION OF THE DRAWINGS

Various embodiments of the invention are disclosed in the following detailed description and the accompanying drawings.

FIG. 1 is a block diagram illustrating an embodiment of a computing infrastructure for the on-chain resolution of contact information.

FIG. 2 is a block diagram illustrating an embodiment of a crypto wallet application capable of performing on-chain resolution of contact information.

FIG. 3 is a flow chart illustrating an embodiment of a process for transferring a crypto asset to a recipient identified by a personal identifier.

FIG. 4 is a flow chart illustrating an embodiment of a process for resolving a personal identifier to a blockchain wallet address.

FIG. 5 is a flow chart illustrating an embodiment of a process for completing a crypto asset transfer using a blockchain wallet address resolved on-chain from a personal identifier.

FIG. 6 is a flow chart illustrating an embodiment of a process for holding a crypto asset in a temporary blockchain wallet when a personal identifier for a recipient does not resolve to a valid blockchain wallet address.

FIG. 7 is a flow chart illustrating an embodiment of a process for completing a crypto asset transaction for a crypto asset held in a temporary blockchain wallet.

FIG. 8 is a diagram illustrating an embodiment of a user interface for transferring a crypto asset to a recipient using a personal identifier.

FIG. 9 is a diagram illustrating an embodiment of a user interface for claiming a crypto asset transferred to a recipient using a personal identifier.

FIG. 10 is a diagram illustrating an embodiment of a user interface for transferring a crypto asset to a recipient using a personal identifier.

FIG. 11 is a functional diagram illustrating a programmed computer system for the on-chain resolution of contact information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The on-chain resolution of personal contact information is disclosed. For example, using the disclosed techniques and systems, a non-blockchain personal identifier, such as an email address or phone number, can be resolved to a blockchain identifier such as a blockchain wallet address. In various embodiments, the disclosed techniques and systems are used to resolve a personal identifier to a public blockchain wallet address allowing a user to transfer a crypto asset using a recipient's non-blockchain identifier, such as a traditional off-chain personal identifier. For example, instead of directly entering a recipient's blockchain wallet address, which can be tedious to input and prone to human error, a user can send a crypto asset to another user by specifying a personal identifier of the recipient, such as the recipient's email address, phone number, driver's license number, physical mailing address, government assigned identifier such as a social security number, school assigned identifier, social media account identifier, or another personal identifier. The provided personal identifier is then translated to a blockchain wallet address by using an on-chain resolution directory. Due to the public nature of the on-chain resolution directory, the personal identifier is first converted to a masked unique identifier, such as a unique identifier for a blockchain wallet, that is calculated using a one-way hash function. For example, a masked unique identifier can be calculated by performing a one-way hash using at least the recipient personal identifier as the input. In some embodiments, the input to the one-way hash function is a combination of the recipient personal identifier and information based on the sender.

In some embodiments, a calculated masked unique identifier, which does not reveal the recipient's personal identifier, is used to resolve the recipient's blockchain wallet address using an on-chain resolution directory. For example, an on-chain resolution directory that is both secure and public utilizes masked unique identifiers instead of each user's personal identifier to index corresponding blockchain identifiers. A recipient's personal identifier is resolved to the correct blockchain wallet address by using the on-chain resolution directory with the associated masked unique identifier of the recipient's personal identifier. The resolved blockchain wallet address is then used to complete the transfer of the crypto asset to the intended recipient. This resolution from an off-chain personal identifier to a public blockchain identifier allows users to address one another using traditional off-chain identifiers in the context of blockchain applications while preserving the expectations of privacy attached to the shared personal identifiers.

In various embodiments, in the event a recipient's personal identifier does not have a corresponding blockchain identifier such as an existing blockchain wallet address, a new wallet with a new blockchain wallet address can be created. The new wallet can function as a temporary holding wallet for a crypto asset. For example, the crypto asset intended for the recipient is transferred to the temporary holding wallet. The recipient is then notified of the pending transfer (such as via the recipient's personal identifier) and can take ownership of the new wallet with the proper verification. For example, once the recipient can verify ownership of the intended recipient's personal identifier, the recipient can take ownership of the temporary holding wallet. In various embodiments, the recipient can then use the temporary holding wallet as the recipient's own blockchain wallet or the recipient can transfer the asset to another wallet. In some embodiments, the automatic creation of the holding wallet with the accompanying crypto asset transfer can function as an efficient and user-friendly onboarding process to introduce new users to blockchain technology. For example, a user with only a personal identifier but no blockchain wallet can have one automatically created with the transfer of a crypto asset directed to the recipient's personal identifier.

In some embodiments, a personal identifier of a recipient of a crypto asset to be sent from a sender is received. The personal identifier includes at least one of the following: an email address, a phone number, a driver's license number, a physical mailing address, a government assigned identifier such as a social security number, a school assigned identifier, or a social media account identifier. For example, a sender initiates the sending of a blockchain crypto asset to a recipient by using a non-blockchain personal identifier for the recipient. A personal identifier is used rather than the recipient's blockchain wallet address, which if known, can be tedious to keep track of and prone to error when manually entered. Instead of the blockchain wallet address, a non-blockchain identifier such as an email address, phone number, or another non-blockchain personal identifier is used to identify the recipient. The crypto asset transfer request can be made through a crypto wallet such as by one running on a sender device and/or accessed via a crypto wallet service. In some embodiments, a crypto wallet client runs on a sender device with access to a backend crypto wallet service. In some embodiments, the crypto wallet runs as a local application on the sender device.

In some embodiments, data stored on a blockchain is used to determine whether a blockchain wallet address is associated with the personal identifier. For example, data on a public blockchain, such as data from an on-chain resolution directory, is used to resolve a non-blockchain personal identifier to a blockchain identifier. The resolution process can utilize a masked unique identifier calculated for the recipient's personal identifier that does not leak the personal identifier. For example, in various embodiments, the masked unique identifier is calculated from the personal identifier using a one-way hash function. In some embodiments, in response to a determination that the blockchain wallet address is associated with the personal identifier, the blockchain wallet address is provided. For example, in the event the on-chain resolution directory links the personal identifier via the masked unique identifier to a valid blockchain wallet address, the blockchain wallet address is provided to the crypto wallet for completing the crypto asset transfer. On the completion of the transfer, the sender and/or recipient can be notified of the successful transfer.

In some embodiments, in response to a determination that no blockchain wallet address is associated with the personal identifier, a new temporary blockchain wallet is generated for the personal identifier. For example, in the event the on-chain resolution directory does not link the personal identifier via the masked unique identifier to a valid blockchain wallet address, a temporary blockchain wallet is generated. The on-chain resolution directory can be updated with the newly generated temporary blockchain wallet such as with the newly generated blockchain wallet address. The registration can be a prospective or conditional registration that is dependent on validating that the intended recipient has ownership or control of the personal identifier. Additionally, the blockchain wallet address of the newly generated wallet is provided to the sender's crypto wallet for completing the crypto asset transfer. In various embodiments, the temporary wallet functions as a holding wallet for the crypto asset until the wallet and/or asset can be claimed. For example, the recipient can be notified of the crypto asset transaction and the ability or option to claim the newly generated wallet holding the crypto asset. In some embodiments, the recipient can claim the wallet and/or crypto asset only after verifying ownership and/or control of the recipient's personal identifier. In some embodiments, once the recipient takes ownership of the temporary blockchain wallet, the wallet is now the recipient's wallet and no longer functions as a temporary or holding wallet. In some embodiments, the recipient can transfer the crypto asset to another wallet of the recipient, for example, by providing an existing recipient blockchain wallet address after verifying ownership of the recipient personal identifier. The crypto asset can then be transferred from the temporary blockchain wallet to the provided recipient blockchain wallet.

In some embodiments, the crypto asset transaction can be reversed, for example, in the event the crypto asset and/or temporary blockchain wallet holding the asset is not claimed. For example, the crypto asset transfer may be reversed and the crypto asset returned to the sender in the event the holding wallet is not claimed within configured conditions, such as within a certain period of time. Other conditions for reversing the transaction can be appropriate as well. For example, a recipient can proactively decline to take ownership of the temporary blockchain wallet and/or the asset resulting in the reversal to the crypto asset transfer.

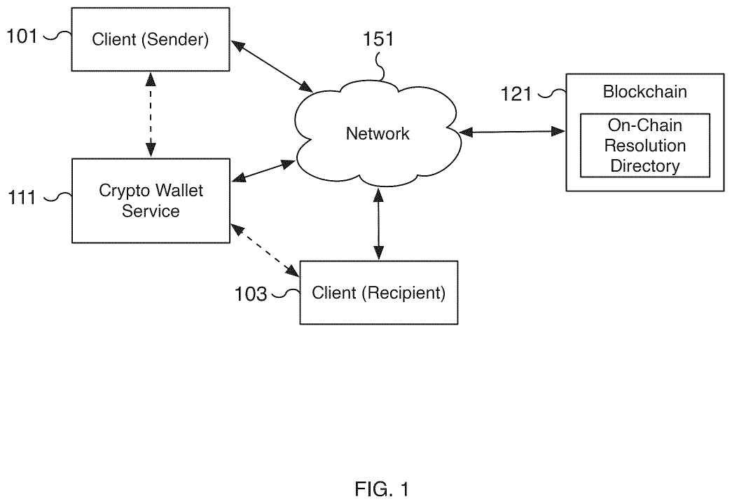

FIG. 1 is a block diagram illustrating an embodiment of a computing infrastructure for the on-chain resolution of contact information. In the example shown, clients 101 and 103 are network clients. Client 101 intends to transfer a crypto asset registered on blockchain 121 from client 101 to client 103 using crypto wallet service 111. Clients 101 and 103, crypto wallet service 111, and blockchain 121 are each communicatively connected to one another via network 151. Network 151 can be a public or private network. In some embodiments, network 151 is a public network such as the Internet. In the example shown, the client 101 designates client 103 as the recipient of the crypto asset transfer by using an off-chain personal identifier of client 103. The off-chain personal identifier is resolved into a blockchain identifier, such as a blockchain wallet address, by crypto wallet service 111. In various embodiments, the resolution process includes calculating a masked unique identifier of the personal identifier. The personal identifier is then resolved to a blockchain identifier using the on-chain resolution directory stored on blockchain 121 indexed by the calculated masked unique identifier. In some embodiments, blockchain 121 is a secure and public distributed ledger and the on-chain resolution directory of blockchain 121 can be publicly accessed including by crypto wallet service 111.

In some embodiments, clients 101 and 103 are each a network computing device for corresponding users. The client devices can correspond to different types of computing devices such as a desktop computer, a laptop, a mobile device, a tablet, a smart home device, a wearable device, or another network computing devices. Client 101 corresponds to a user that acts as the sender of a crypto asset. For example, using client 101, the sending user can manage a crypto asset registered on blockchain 121 including the transfer of the crypto asset to another user such as the user of client 103. In the example shown, client 103 corresponds to the recipient user of a crypto asset transfer. In various embodiments, the recipient may or may not have a crypto wallet with a blockchain wallet address. In either case, the sender does not need to know the recipient's blockchain wallet address and instead uses a non-blockchain personal identifier of the recipient (such as an email address) in place of a blockchain identifier. In various embodiments, the sender initiates the transfer of a crypto asset at client 101 to the recipient at client 103 using crypto wallet service 111 by identifying the crypto asset and providing the personal identifier associated with the user of client 103.

In some embodiments, crypto wallet service 111 is a crypto wallet for performing blockchain transactions on crypto assets. For example, crypto wallet service 111 can transfer a crypto asset from one blockchain wallet address to another blockchain wallet address. Additionally, crypto wallet service 111 is enabled with the disclosed functionality to transfer a crypto asset when provided with a non-blockchain personal identifier for the recipient instead of the recipient's blockchain wallet address. As part of the transfer process, crypto wallet service 111 can resolve the blockchain personal identifier to a blockchain identifier such as a blockchain wallet address. When a personal identifier does not resolve to a valid blockchain wallet address, crypto wallet service 111 can create a new blockchain wallet with a corresponding blockchain wallet address. For example, when a recipient's personal identifier does not resolve to a blockchain wallet address, crypto wallet service 111 can create a temporary blockchain wallet and transfer the asset into the temporary wallet. Crypto wallet service 111 can then notify the intended recipient about the transfer and the ability or option to claim the asset and/or temporary blockchain wallet. In some embodiments, crypto wallet service 111 performs a verification process to verify a user claiming the temporary blockchain wallet with the crypto asset has ownership of the personal identifier. Once a recipient is verified, crypto wallet service 111 can assign ownership of the temporary blockchain wallet and/or the associated crypto asset to the recipient. In various embodiments, the crypto asset is registered using blockchain 121 and crypto wallet service 111 is configured to read from and write to blockchain 121.

Although only a single blockchain is shown in FIG. 1, crypto wallet service 111 can be configured with multiple blockchain services. Additionally, although crypto wallet service 111 is shown in FIG. 1 as a service component separate from client 101 and/or client 103, the functionality of crypto wallet service 111 can be performed by a local application running on clients 101 and/or 103. For example, crypto wallet service 111 can be implemented as an application that runs on client 101 to send a crypto asset from a sender associated with client 101 to a recipient associated with client 103. In some embodiments, crypto wallet service 111 includes a client application that is not shown in FIG. 1, such as a thin application client or a web browser interface, for accessing the services offered by crypto wallet service 111.

In some embodiments, blockchain 121 corresponds to a blockchain network service and can represent a public digital ledger distributed across multiple computing devices. Blockchain 121 is used by crypto wallet service 111 to manage and/or store digital or crypto assets such as non-fungible tokens (NFTs), cryptocurrencies, and smart contracts, among other types of crypto assets. In some embodiments, blockchain 121 is a multi-layer blockchain. In the example shown, blockchain 121 includes blockchain data and/or records for an on-chain resolution directory. The on-chain resolution directory is stored and replicated across blockchain 121 and corresponds to a public directory for resolving blockchain wallet addresses. In some embodiments, the on-chain resolution directory is implemented as a blockchain smart contract. In some embodiments, a version of the on-chain resolution directory can exist off-chain but the on-chain version is the authoritative version and is used as the source of truth. For example, the off-chain version can be used for potentially faster resolution processing and/or for off-line scenarios, but the resolved blockchain wallet address may be confirmed using the on-chain resolution directory.

In various embodiments, the on-chain resolution directory is indexed by a masked unique identifier that can only be calculated with the knowledge of a corresponding personal identifier. For example, the masked unique identifier can be calculated by performing a one-way hash on a personal identifier. The masked unique identifier used to index the on-chain resolution directory is a masked identifier because each masked unique identifier does not leak its corresponding personal identifier. Additionally, the masked unique identifier is a unique identifier because each masked unique identifier corresponds to a single personal identifier.

In various embodiments, the components shown in FIG. 1 may exist in various combinations of software programs and/or hardware machines. Although single instances of some components have been shown to simplify the diagram, additional instances of any of the components shown in FIG. 1 may exist. For example, crypto wallet service 111 and blockchain 121 can each include one or more servers including distributed servers as well as shared or partially shared servers. As additional examples, clients 101 and 103 are just one example of a sender and recipient pair for transferring digital assets via a crypto wallet, and crypto wallet service 111 is just one example of a crypto wallet implementation for transferring a crypto asset using a non-blockchain personal identifier. For example, two independent crypto wallets can exist, one for each of client 101 and client 103, including instances running locally at client 101 and/or client 103. In some embodiments, components not shown in FIG. 1 may also exist.

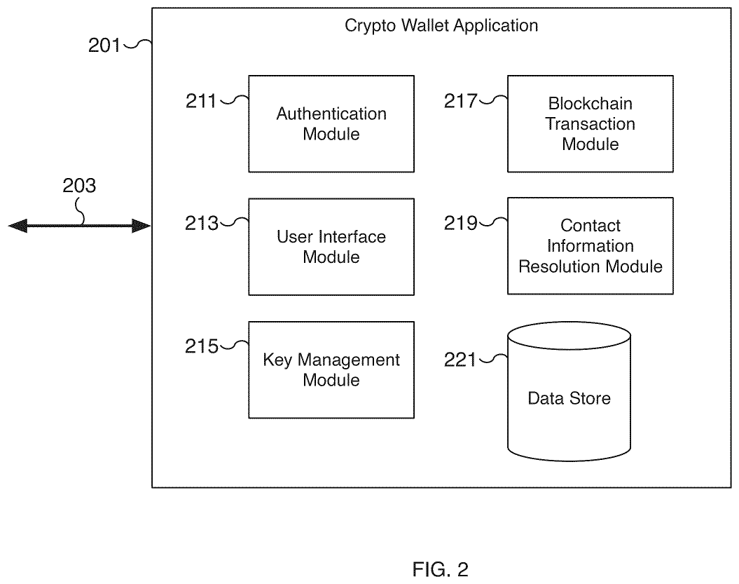

FIG. 2 is a block diagram illustrating an embodiment of a crypto wallet application capable of performing on-chain resolution of contact information. In the example shown, crypto wallet application 201 includes network connection 203, authentication module 211, user interface module 213, key management module 215, blockchain transaction module 217, contact information resolution module 219, and data store 221. Crypto wallet application 201 implements the functionality of a blockchain wallet for performing blockchain transactions on crypto assets and is additionally enabled with the disclosed functionality to transfer a crypto asset when provided with a non-blockchain personal identifier for the recipient. For example, crypto wallet application 201, using at least contact information resolution module 219, can resolve a recipient's non-blockchain personal identifier, such as an email address or phone number, to the recipient's blockchain wallet address. Additionally, crypto wallet application 201 can create a new wallet with a corresponding new blockchain wallet address to function as a temporary holding wallet for the crypto asset in the event the resolution is not successful, such as in the event the recipient does not have a known or existing blockchain wallet address associated with the personal identifier. Crypto wallet application 201 can further manage the process of verifying that the recipient owns or controls the recipient's personal identifier. If properly verified, crypto wallet application 201 can then transfer ownership of the temporary holding wallet to the recipient, allowing the recipient to claim the temporary holding wallet that holds the crypto asset.

In some embodiments, crypto wallet application 201 is an application that executes locally on a computing device and performs blockchain transactions from the client device without requiring access to a remote crypto wallet service. A client application version of crypto wallet application 201 can be implemented as a local application. Examples of a local client application version of crypto wallet application 201 include a desktop software application, a mobile software app, a web browser plug-in, a web browser extension, a dedicated hardware crypto wallet, or another form of a local application. In various embodiments, a client application version of crypto wallet application 201 can run independently on a client device such as on client 101 or client 103 of FIG. 1 without the need to access a remote crypto wallet service, such as to access the blockchain for managing crypto assets.

In some embodiments, crypto wallet application 201 is implemented as a crypto wallet service and crypto wallet application 201 corresponds to crypto wallet service 111 of FIG. 1. Although not shown in FIG. 2 with a separate client and server division, crypto wallet application 201 can be implemented as a client/server application such as with a thin client that accesses crypto wallet services of a crypto wallet server. In some embodiments, the thin software client corresponds to a local application, such as a web browser, a web browser plug-in, a web browser extension, or a local stand-alone client application that executes locally on a computing device such as client 101 of FIG. 1 to access remote crypto wallet services running on a corresponding server component. In some embodiments, the client and server components can execute on the same computing device and the client can access the server via a local networking connection. Although the components of crypto wallet application 201 are shown together, depending on the implementation, they may be divided and/or shared between client and server elements. In some embodiments, additional components of crypto wallet application 201 may exist that are not shown.

In some embodiments, network connection 203 is a network connection used by crypto wallet application 201 to communicate with other services including the blockchain and potential third-party verification services. For example, using network connection 203, blockchain transaction module 217 can read and write from a blockchain and contact information resolution module 219 can verify the owner of a recipient's personal information. In some embodiments, network connection 203 is further used to notify a recipient of a crypto asset transaction, such as to notify a recipient that a newly generated temporary blockchain wallet with a transferred crypto asset is available to be claimed. In some embodiments, multiple instances of network connection 203 exist and can be utilized by components to crypto wallet application 201 to communicate with other components of crypto wallet application 201, such as when crypto wallet application 201 is implemented using a client/server architecture. In some embodiments, network connection 203 allows crypto wallet application 201 to connect with a network such as network 151 of FIG. 1.

In some embodiments, authentication module 211 is a processing module for performing user authentication. For example, authentication module 211 can be used to verify the owner of a wallet managed by crypto wallet application 201. In some embodiments, crypto wallet application 201 requires that the owner of a wallet managed by crypto wallet application 201 provide a password, a pass phrase, a recovery phrase, a biometric password, a hardware verification, or another form of authentication as part of a user verification process. Other techniques, such as token-based, certificate-based, multi-factor, or knowledge-based, among other authentication techniques may be appropriate as well. In some embodiments, authentication module 211 utilizes key management module 215 for verifying the user and/or a third-party service such as a cloud-based verification service for verifying the user.

In some embodiments, user interface module 213 is a processing module for implementing a user interface for crypto wallet application 201. For example, user interface module 213 implements a user interface that allows a user to log into a crypto wallet managed by crypto wallet application 201 and to initiate the transfer of a crypto asset to a recipient by specifying either a personal identifier or a blockchain wallet address. In various embodiments, user interface module 213 also provides a user interface for notifying users of the status of a transferred asset, for verifying the ownership or control of a personal identifier involved in a crypto asset transfer, and for claiming ownership of a temporary blockchain wallet involved in a crypto asset transfer and/or of the crypto asset involved in the transfer. User interface module 213 is also used to implement other features of the user interface for crypto wallet application 201 including functionality related to managing blockchain crypto assets.

In some embodiments, key management module 215 is a processing module for managing the secure storage and management of keys including private keys used to access and control the user's digital crypto assets. For example, key management module 215 is integral in ensuring the security and privacy of the assets managed by crypto wallet application 201. In some embodiments, key management module 215 includes functionality to generate keys including a private/public key pair, to encrypt the managed keys including against unauthorized access, and for key backup and recovery. Key management module 215 may also be used for access control including for access control related to user authentication. For example, key management module 215 can be used along with authentication module 211 to implement user authentication. In some embodiments, key management module 215 is utilized to help generate a new temporary blockchain wallet, for example, for holding a crypto asset for a recipient without a registered blockchain wallet. In some embodiments, key management module 215 utilizes data store 221 at least in part for the secure storage of keys.

In some embodiments, blockchain transaction module 217 is a processing module for performing blockchain transactions. For example, the components of crypto wallet application 201 can utilize blockchain transaction module 217 to perform read and write actions to a blockchain network. In various embodiments, blockchain transaction module 217 is used by contact information resolution module 219 to resolve a masked unique identifier associated with a personal identifier by accessing an on-chain resolution direction. Similarly, when a new blockchain wallet is generated, blockchain transaction module 217 is used to update the on-chain resolution directory to allow the associated personal identifier to resolve to the blockchain wallet address of the newly generated blockchain wallet. In various embodiments, blockchain transaction module 217 can support multiple different blockchain networks and its implementation ensures combability with the configured blockchain networks and integration with other blockchain applications.

In some embodiments, contact information resolution module 219 is a processing module for transferring a crypto asset to a recipient identified only by a personal identifier and not by a blockchain wallet address. Contact information resolution module 219 can resolve the personal identifier to a blockchain wallet address if one exists. If no blockchain wallet address resolves for the recipient's personal identifier, contact information resolution module 219 can create a new temporary blockchain wallet with a corresponding blockchain wallet address and transfer the crypto asset to the newly created wallet. The recipient is notified, for example, via the personal identifier such as via email or a text message. In some embodiments, contact information resolution module 219 verifies ownership or control of the personal identifier before transferring ownership of the newly created wallet to the recipient. In some embodiments, contact information resolution module 219 can receive a target blockchain wallet address after a recipient has verified ownership/control of the personal identifier and the crypto asset is transferred from the temporary wallet to the provided target wallet.

In some embodiments, one or more of these steps of the described crypto asset transfer managed by contact information resolution module 219 are implemented at least in part by components of crypto wallet application 201 such as authentication module 211, user interface module 213, key management module 215, blockchain transaction module 217, and data store 221. In some embodiments, one or more of these steps can also be performed by using a third-party service. For example, contact information resolution module 219 can utilize a third-party verification service for performing the verification of a recipient's personal identifier. As another example, notification of an intended crypto asset transfer along with the option to claim the temporary wallet and associated asset can be performed using a third-party verification service, such as an email relay service. In some embodiments, one or more of the steps such as the verification, notification, and/or temporary wallet assignment steps are performed and/or implemented by a separate component other than contact information resolution module 219.

In some embodiments, contact information resolution module 219 resolves a personal identifier to a blockchain identifier by first determining a masked unique identifier for the personal identifier. For example, contact information resolution module 219 can apply a one-way hash function to the personal identifier to calculate a masked unique identifier that does not reveal the personal identifier. Using an on-chain resolution dictionary, contact information resolution module 219 can retrieve a registered blockchain wallet address using the calculated masked unique identifier as an index or lookup key. In the event a blockchain wallet address is registered for the personal identifier, contact information resolution module 219 can use the resolved blockchain wallet address to complete the intended crypto asset transfer. In the event there is no blockchain wallet address registered for the personal identifier, contact information resolution module 219 can create a temporary blockchain wallet to temporarily hold the crypto asset until the wallet and/or asset can be claimed by the recipient.

In some embodiments, data store 221 corresponds to one or more data sources used by crypto wallet application 201. Data store 221 can include local and remote or distributed storage. In some embodiments, data store 221 is used for the secure storage of keys such as one or more private keys associated with the managed crypto assets of crypto wallet application 201. Data store 221 can also be used for storing user profile information, transaction history, account balances, configuration settings, and account information including contact information of other users, among other data. In various embodiments, data store 221 includes a form of secure storage and utilizes various forms of encryption methods to protect against unauthorized access.

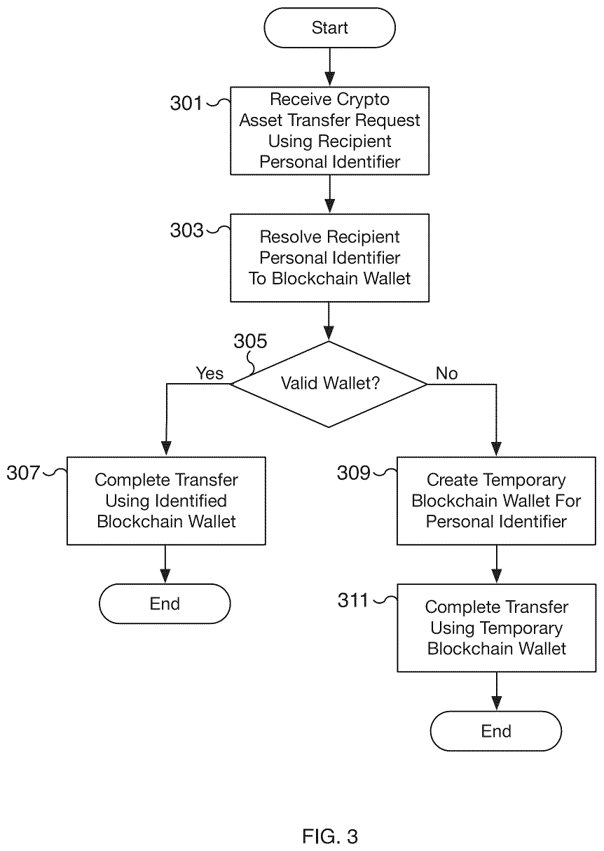

FIG. 3 is a flow chart illustrating an embodiment of a process for transferring a crypto asset to a recipient identified by a personal identifier. Using the process of FIG. 3, a blockchain crypto asset can be transferred to a recipient without knowledge of the recipient's blockchain wallet address by resolving the personal identifier to a blockchain identifier using an on-chain resolution directory. In the event the personal identifier does not resolve to a blockchain identifier, a temporary holding wallet is created for the crypto asset and the recipient can claim the newly created wallet with the transferred crypto asset. In some embodiments, the process of FIG. 3 is performed by a crypto wallet such as crypto wallet service 111 of FIG. 1 and/or crypto wallet application 201 of FIG. 2. In some embodiments, a blockchain network such as blockchain 121 of FIG. 1 is used to register the crypto asset as well as to maintain an on-chain resolution directory. In some embodiments, the sender and recipients of the crypto asset correspond to clients 101 and 103, respectively, of FIG. 1.

At 301, a crypto asset transfer request using a recipient personal identifier is received. For example, a user of a crypto wallet initiates a transfer of a crypto asset to a recipient by specifying a personal identifier of the recipient. The personal identifier can be a non-blockchain identifier and is not a blockchain wallet address, which is typically used to specify the recipient of a crypto asset transfer. Examples of a personal identifier include an email address, a phone number, a driver's license number, a physical mailing address, a social security number, a government assigned identifier, a school assigned identifier, or a social media account identifier. Other examples of a personal identifier include a physical address such as a home or residence address, a passport number, a national insurance number, a taxpayer identification number, a credit card number, or a bank account number. The personal identifier is not limited to individuals and can also be a personal identifier for an entity such as a company or organization. For example, a personal identifier can include a company name, a company address, a company bank account number, a company stock symbol, or another group identifier. In various embodiments, the persona identifier may be shared with trusted sources but is a privacy sensitive identifier and can also carry an expectation of privacy. For example, a user may want to limit the sharing of an email address, phone number, physical mailing address such as a home address, driver's license number, social security number, or social media account identifier to a trusted circle of contacts. Unlike a blockchain network where data transparency is emphasized, there may be an expectation that the personal identifier should not be publicly exposed.

At 303, the recipient personal identifier is resolved to a blockchain wallet. For example, the personal identifier is converted to a masked unique identifier that does not reveal the personal identifier if exposed. In some embodiments, the masked unique identifier is calculated using a one-way hash on at least a portion of the personal identifier. In some embodiments, other data can be used in addition to the personal identifier for calculating the masked unique identifier. For example, a portion of the identifiers for the sender and recipient can be used together for calculating the masked unique identifier. Once a masked unique identifier for the persona identifier is determined, an on-chain resolution directory can be used that maps the masked unique identifier to a potential blockchain wallet address. In the event a valid blockchain wallet is registered for the personal identifier, the blockchain wallet address is retrieved from the blockchain using the on-chain resolution directory. In the event a valid blockchain wallet is not registered with the personal identifier, the on-chain resolution directory will indicate that there is no current registered valid blockchain wallet and corresponding blockchain wallet address for the personal identifier. In various embodiments, the on-chain resolution directory uses the masked unique identifier as a key for looking up or resolving the corresponding blockchain identifier, and revealing the masked unique identifier in public does not expose or reveal the corresponding personal identifier. In some embodiments, multiple blockchain identifiers or blockchain wallet addresses can be registered for the same personal identifier and the personal identifier resolves to all the registered blockchain wallet addresses.

At 305, a determination is made whether the recipient personal identifier resolves to a valid blockchain wallet. In the event the resolution results in a valid blockchain wallet, processing proceeds to 307, where the crypto asset transfer is completed using the resolved blockchain wallet address. In the event the resolution does not result in a valid wallet, processing proceeds to 309.

At 307, the transfer of the crypto asset is completed using the identified blockchain wallet. For example, the crypto asset is transferred to the recipient using the resolved recipient blockchain wallet. In various embodiments, the blockchain wallet address is used to transfer the crypto asset from the sender to the recipient. Upon completion, the sender and/or the recipient can be notified of the completed transfer.

At 309, a temporary blockchain wallet is created for the personal identifier. For example, a new blockchain wallet with a corresponding blockchain wallet address is created. In some embodiments, the new blockchain wallet is registered with the on-chain resolution directory. For example, the on-chain resolution directory can be updated with the newly generated temporary blockchain wallet such as with the newly generated blockchain wallet address. The registration can be a prospective or conditional registration that is dependent on validating that the intended recipient has ownership or control of the personal identifier.

At 311, the transfer is completed using the temporary blockchain wallet. For example, the crypto asset is transferred to the temporary blockchain wallet using the blockchain wallet address of the temporary blockchain wallet. In some embodiments, the temporary blockchain wallet functions as a holding wallet until the crypto asset and/or temporary wallet can be claimed by the recipient. Upon completion of the transfer of the crypto asset to the temporary blockchain wallet, the sender and/or the recipient can be notified of the intended transfer. For example, the recipient can be notified of the crypto asset transaction and the ability to claim the newly generated wallet holding the crypto asset. In some embodiments, the recipient can claim the wallet and/or crypto asset only after verifying ownership and/or control of the recipient's personal identifier. In some embodiments, once the recipient takes ownership of the temporary blockchain wallet, the wallet is now the recipient's wallet and no longer functions as a temporary or holding wallet. In some embodiments, the recipient can transfer the crypto asset to another wallet of the recipient, for example, by providing an existing recipient blockchain wallet address after verifying ownership of the recipient personal identifier. The crypto asset can then be transferred from the temporary blockchain wallet to the provided recipient blockchain wallet.

In some embodiments, the crypto asset transaction can be reversed, for example, in the event the crypto asset and/or temporary blockchain wallet holding the asset are not claimed or the transaction is rejected or voided. For example, the crypto asset transfer may be reversed and the crypto asset returned to the sender in the event the holding wallet is not claimed within configured conditions, such as within a certain period of time. Other conditions for reversing the transaction can be appropriate as well. For example, a recipient can proactively decline to take ownership of the temporary blockchain wallet and/or the asset resulting in the reversal to the crypto asset transfer. As another example, the sender can proactively void the transaction and initiate a reversal to the crypto asset transfer. In various embodiments, the approach used to complete the transfer of the crypto asset can be differ and may be configured with the crypto wallet used to initiate the transfer.

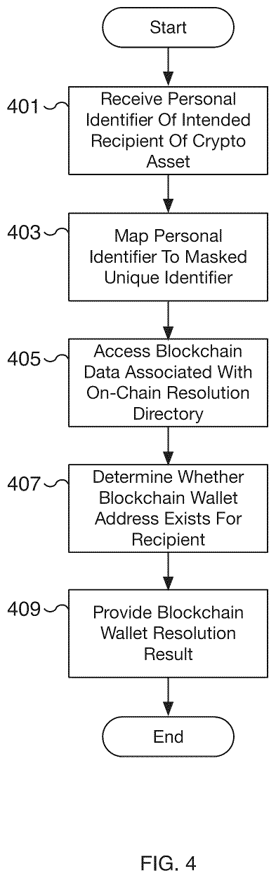

FIG. 4 is a flow chart illustrating an embodiment of a process for resolving a personal identifier to a blockchain wallet address. Using the process of FIG. 4, a personal identifier used to specify a recipient of a crypto asset transfer is resolved to a valid or invalid blockchain wallet. The resolution result can return a valid blockchain wallet address based on an on-chain personal identifier resolution. Alternatively, the resolution result can return that no valid blockchain wallet exists for the personal identifier. In some embodiments, the process is used to allow a recipient to share a personal identifier for receiving a crypto asset transfer without the personal identifier being publicly shared on the blockchain network. In some embodiments, the process of FIG. 4 is performed at 301, 303, and/or 305 of FIG. 3 by a crypto wallet such as crypto wallet service 111 of FIG. 1 and/or crypto wallet application 201 of FIG. 2. In some embodiments, data from a blockchain network such as blockchain 121 of FIG. 1 is used to resolve the personal identifier.

At 401, a personal identifier of an intended recipient of a crypto asset is received. For example, a non-blockchain identifier of an intended recipient is received. The personal identifier can correspond to an email address, phone number, home address, or another personal identifier with some expectation of privacy. For example, the personal identifier may be an identifier provided by a sender that the recipient was willing to share between trusted contacts but does not want the identifier to be shared publicly such as on the blockchain network. In various embodiments, the personal identifier is provided by the sender to initiate to send the crypto asset to the recipient.

At 403, the personal identifier is mapped to a masked unique identifier. For example, the personal identifier is mapped to a masked unique identifier that can be publicly shared without revealing the personal identifier. For example, using a one-way hash function, a hash of the personal identifier can be calculated to determine a corresponding masked unique identifier. In some embodiments, the hash function or another one-way function applied is a documented public standard and any crypto wallet or similar service can compute the corresponding masked unique identifier from a personal identifier. In some embodiments, the masked unique identifier includes a portion of information based on the sender. For example, the masked unique identifier can be computed by applying a one-way function on the concatenation of a sender personal identifier (e.g., alice@example.com) with the intended recipient personal identifier (e.g., bob@example.com). The concatenated string (e.g., alice@example.com+bob@example.com) is hashed to create a masked unique identifier that is unique for the sender and recipient pair. Other approaches for calculating the masked unique identifier may be appropriate as well.

At 405, blockchain data associated with an on-chain resolution directory is accessed. For example, data or records stored on the blockchain can be accessed by the crypto wallet using the masked unique identifier as a lookup key or index. In various embodiments, in the event a blockchain wallet address is registered for the masked unique identifier, the on-chain resolution directory maps the masked unique identifier to the registered blockchain wallet address. Accessing the on-chain resolution directory mapping using the masked unique identifier will return the registered blockchain wallet address. Alternatively, in the event no blockchain wallet address is registered for the masked unique identifier, accessing the on-chain resolution directory mapping using the masked unique identifier will not return a valid blockchain wallet and/or will return an equivalent indication that no blockchain wallet address can be resolved for the personal identifier. In some embodiments, at 405, the on-chain resolution directory is accessed using the masked unique identifier to return the corresponding blockchain records or entries for either a valid or invalid blockchain wallet resolution result. In some embodiments, the returned result includes an on-chain proof of the resolution that can be verified. For example, a cryptographic proof representing the personal identifier and its ownership can be stored on-chain to verify resolution results.

At 407, a determination is made on whether a blockchain wallet address exists for the recipient. For example, based on the resolution result determined at 405, either a valid or invalid blockchain wallet resolution result is returned. In some embodiments, a valid blockchain wallet resolution result includes an indication of a valid registered blockchain wallet and the registered blockchain wallet address, whereas an invalid blockchain wallet resolution result includes an indication that no blockchain wallet address is registered for the personal identifier. In some embodiments, the resolution result includes an on-chain cryptographic proof that can be verified. For example, a cryptographic proof representing the personal identifier and its ownership can be verified to confirm the validity of the associated blockchain wallet address. In the event a successful resolution with a blockchain wallet address is returned from step 405, a determination is made that a blockchain wallet address exists for the recipient. In the event the resolution fails and no valid (or an invalid) blockchain wallet address is returned from step 405, a determination is made that a blockchain wallet address does not exist for the recipient.

At 409, a blockchain wallet resolution result is provided. For example, in the event a determination is made at 407 that the personal identifier resolves to a blockchain wallet address, the blockchain wallet address is returned as a valid blockchain wallet resolution result. Alternatively, a determination is made at 407 that the personal identifier does not resolve in a blockchain wallet address and a resolution result indicating that the personal identifier does not have a registered blockchain wallet is returned as a resolution result. In some embodiments, the failure to map the personal identifier to a registered blockchain wallet address is returned as an invalid or non-existing blockchain wallet result.

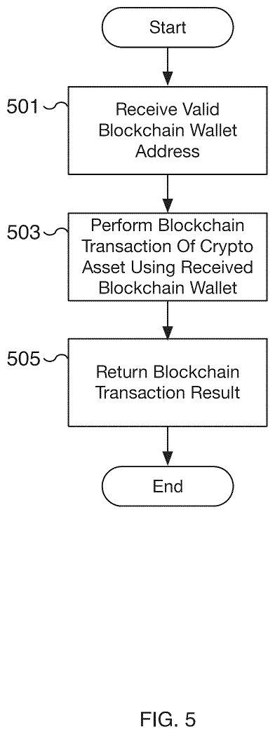

FIG. 5 is a flow chart illustrating an embodiment of a process for completing a crypto asset transfer using a blockchain wallet address resolved on-chain from a personal identifier. Using the process of FIG. 5, a request to transfer a crypto asset to a recipient identified by a personal identifier is completed using the blockchain wallet address resolved using an on-chain resolution directory. In some embodiments, the process of FIG. 5 is performed at 307 of FIG. 3 by a crypto wallet such as crypto wallet service 111 of FIG. 1 and/or crypto wallet application 201 of FIG. 2. In some embodiments, the blockchain wallet address is resolved on-chain from the personal identifier using the processes of FIGS. 3 and/or 4. In some embodiments, the transfer of the crypto asset from a sender to a recipient, such as from the user of client 101 of FIG. 1 to the user of client 103 of FIG. 1, is registered on a blockchain network such as blockchain 121 of FIG. 1.

At 501, a valid blockchain wallet address is received. For example, the resolution of a personal identifier to a blockchain wallet address is successful and the recipient's registered blockchain wallet address is received. In some embodiments, the resolution is performed by a contact information resolution module of a crypto wallet such as contact information resolution module 219 of FIG. 2. In some embodiments, the contact information resolution module is implemented as part of a crypto wallet service.

At 503, a blockchain transaction of the crypto asset is performed using the received blockchain wallet address. For example, the crypto asset specified by the sender in a transaction request is transferred to the recipient using the resolved recipient blockchain wallet address received at 501. In various embodiments, the blockchain wallet address is used to transfer the crypto asset from the sender to the recipient using the configured blockchain network. In some embodiments, the one or more keys stored by the crypto wallet are accessed to perform the blockchain transaction by using a key management module of a crypto wallet, such as key management module 215 of FIG. 2. In some embodiments, the blockchain network is accessed via a blockchain transaction module of a crypto wallet such as blockchain transaction module 217 of FIG. 2.

At 505, a blockchain transaction result is returned. For example, a result of the blockchain transaction, such as a transaction success or transaction failure, is returned. Based on the returned blockchain transaction result, the crypto wallet can notify the sender and/or the recipient with the appropriate notifications. For example, in the event a blockchain transaction result is successful, the account balance of the sender's wallet can be updated and the recipient can be notified of the transfer. In some embodiments, the crypto wallet can implement a failure or fallback process to address a failed blockchain transaction result, such as offering the sender an opportunity to resend the crypto asset including an opportunity to modify the parameters of the crypto asset transaction request.

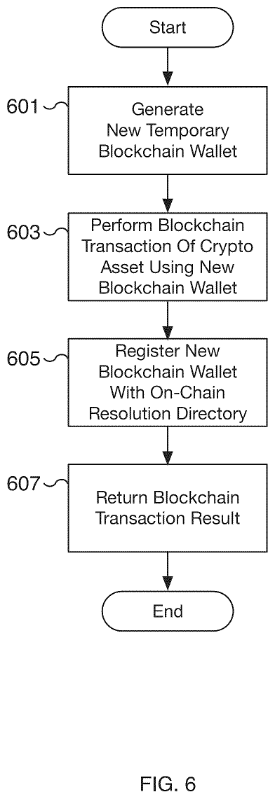

FIG. 6 is a flow chart illustrating an embodiment of a process for holding a crypto asset in a temporary blockchain wallet when a personal identifier for a recipient does not resolve to a valid blockchain wallet address. Using the process of FIG. 6, a temporary blockchain wallet is created, and the temporary wallet is used to hold a crypto asset intended for a recipient without a confirmed blockchain wallet. In some embodiments, the process of FIG. 6 is performed at 309 and/or 311 of FIG. 3 by a crypto wallet such as crypto wallet service 111 of FIG. 1 and/or crypto wallet application 201 of FIG. 2. In some embodiments, the personal identifier of the recipient did not resolve to a blockchain wallet address using the processes of FIGS. 3 and/or 4. In some embodiments, the temporary blockchain wallet used to attempt a crypto asset transfer of the crypto asset from a sender to a recipient, such as from the user of client 101 of FIG. 1 to the user of client 103 of FIG. 1, is registered on a blockchain network such as blockchain 121 of FIG. 1.

At 601, a new temporary blockchain wallet is generated. For example, a new blockchain wallet with a corresponding blockchain wallet address is created on a blockchain network. In various embodiments, the private and public key of the new wallet are stored securely by the crypto wallet and access to the wallet is limited. For example, the private key and wallet address can be managed and stored by a key management module of a crypto wallet, such as key management module 215 of FIG. 2. In some embodiments, the owner of the new temporary blockchain wallet is the sender that initiated the crypto asset transfer. In some embodiments, the owner of the new temporary blockchain wallet can be a trusted intermediary such as an escrow service.

At 603, a blockchain transaction of the crypto asset is performed using the newly generated blockchain wallet. For example, the crypto asset specified by the sender in a transaction request is transferred to the blockchain wallet address of the new generated temporary wallet. The temporary blockchain wallet functions as a holding wallet until the crypto asset and/or temporary wallet can be claimed by the recipient. In some embodiments, the one or more keys stored by the crypto wallet are accessed to perform the blockchain transaction by using a key management module of a crypto wallet, such as key management module 215 of FIG. 2. In some embodiments, the blockchain network is accessed via a blockchain transaction module of a crypto wallet such as blockchain transaction module 217 of FIG. 2.

At 605, the newly generated blockchain wallet is registered with the on-chain resolution directory. For example, the on-chain resolution directory used to resolve a personal identifier to a blockchain wallet address is updated to register the recipient's personal identifier to the blockchain wallet address of the newly generated wallet. In some embodiments, the registration is a prospective or conditional registration that is dependent on validating that the intended recipient has ownership or control of the personal identifier. In various embodiments, the registration process requires determining the masked unique identifier for the recipient's personal identifier that is used as a key or index for the on-chain resolution directory. The masked unique identifier can be determined using a one-way hash function and may be cached from a previous on-chain contact resolution attempt using the recipient's personal identifier that did not result finding a valid blockchain wallet.

At 607, a blockchain transaction result is returned. For example, a result of the blockchain transaction to transfer the crypto asset to the holding wallet, such as a transaction success or transaction failure, is returned. Based on the returned blockchain transaction result, the crypto wallet can notify the sender and/or the recipient with the appropriate notifications. For example, in the event the transaction of the crypto asset into the holding wallet is successful, the sender's wallet can be updated indicating the status of the crypto asset transfer. Additionally, the recipient can be notified of the crypto asset transaction and the ability to claim the newly generated wallet holding the crypto asset. In some embodiments, the recipient can claim the wallet and/or crypto asset only after verifying ownership and/or control of the recipient's personal identifier.

In some embodiments, in the event of a failed blockchain transaction result, the crypto wallet can implement a failure or fallback process, such as offering the sender an opportunity to resend the crypto asset including an opportunity to modify the parameters of the crypto asset transaction request. As part of the failure or fallback process, any transactions to move the crypto asset may be reversed, as appropriate. For example, the crypto asset may be transferred from the blockchain wallet newly generated at 603 back to the sender's wallet and/or the on-chain resolution directory can be updated to remove the registration associated with the newly generated blockchain wallet.

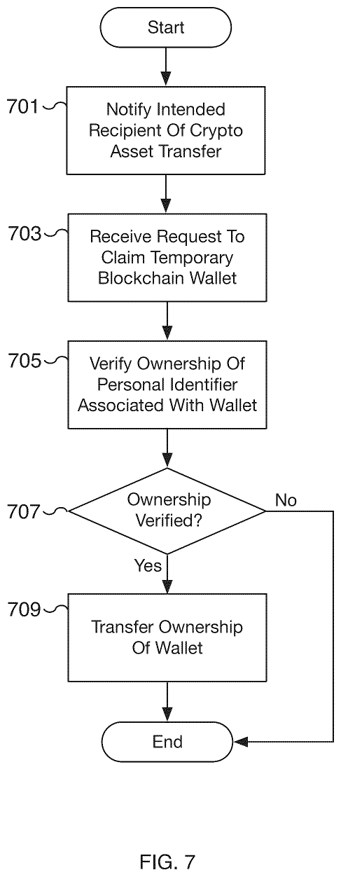

FIG. 7 is a flow chart illustrating an embodiment of a process for completing a crypto asset transaction for a crypto asset held in a temporary blockchain wallet. Using the process of FIG. 7, the intended recipient of a crypto asset can claim the temporary blockchain wallet and/or the crypto asset held by the temporary blockchain wallet. In some embodiments, the claiming process includes verifying ownership and/or control of a personal identifier used to transfer the crypto asset into the temporary blockchain wallet. In some embodiments, the temporary blockchain wallet is used when the recipient of the crypto asset is identified by the sender by a personal identifier instead of by the recipient's blockchain wallet address. In some embodiments, the process of FIG. 7 is performed at 311 of FIG. 3 by a crypto wallet such as crypto wallet service 111 of FIG. 1 and/or crypto wallet application 201 of FIG. 2. In some embodiments, the personal identifier of the recipient used by the sender did not resolve to a valid blockchain wallet address using the processes of FIGS. 3 and/or 4 resulting in the use of the temporary blockchain wallet as described by the process of FIG. 6. In some embodiments, the temporary blockchain wallet used for the crypto asset transfer from a sender to a recipient, such as from the user of client 101 of FIG. 1 to the user of client 103 of FIG. 1, is registered on a blockchain network such as blockchain 121 of FIG. 1.

At 701, the intended recipient of a crypto asset transfer is notified. For example, the intended recipient can be notified using the provided personal identifier of the recipient, such as a provided email address or phone number. In various embodiments, the recipient is notified of the crypto asset transaction and the ability to claim the newly generated wallet holding the crypto asset by verifying ownership and/or control of the personal identifier used to initiate the transaction. In some embodiments, the notification includes a unique token that can be used to help verify the identity of the recipient.

At 703, a request to claim the temporary blockchain wallet is received. For example, a potential and unverified recipient will request ownership of the temporary blockchain wallet and at 703, the request is received. In some embodiments, the request is received by the crypto wallet that currently owns the temporary blockchain wallet. In some embodiments, the request is made to claim ownership of only the crypto asset held by the temporary blockchain wallet and not for additional ownership of the temporary blockchain wallet. In various embodiments, the notification sent at 701 can include a token that can be used to help verify the recipient's identity. The token can be included in the request received at 703 to help confirm that the requester has the same identity as the recipient of the notification request sent at 701.

At 705, ownership of the personal identifier associated with the wallet is verified. For example, the identity of the potential and unverified recipient claiming the temporary blockchain wallet is verified. In some embodiments, the verification includes confirming ownership or control of the personal identifier used to initiate the crypto asset transfer. For example, the verification process can include confirmation of a verification code sent to the recipient via the personal identifier (such as via an email or text message). In some embodiments, a verification token is included in the initial notification sent at 701. In various embodiments, the verification may require additional verification in addition to verifying ownership or control of the personal identifier and/or the verification can be performed using a third-party verification service. For example, additional factors of authentication may be required in addition to the personal identifier. A second form (or more) of verification may be required such as ownership of both an email address and a phone number.

At 707, a determination is made whether ownership of the personal identifier has been verified. In the event verification of the ownership (or control) of the personal identifier is successful, processing proceeds to 709. In the event verification of the ownership (or control) of the personal identifier is not successful, processing completes. In some embodiments, the process of FIG. 7 can be repeated including starting at step 703 in the event a new request for claiming the temporary blockchain wallet is received.

At 709, ownership of the temporary blockchain wallet is transferred. For example, ownership of the temporary blockchain is assigned to the recipient. In various embodiments, the recipient is now in control of the temporary blockchain wallet and any previous ownership of the temporary blockchain wallet is relinquished. In some embodiments, the wallet is minted along with the personal identifier of the recipient. Once ownership of the temporary blockchain wallet is transferred to the recipient, the wallet no longer functions as a temporary or holding wallet and is instead under the control and management of the recipient. By transferring ownership of the wallet to the recipient, the crypto asset held by the wallet is also transferred to the recipient.

In some embodiments, the recipient may request ownership of only the crypto asset and not the temporary blockchain wallet. In the event the recipient declines ownership of the temporary blockchain wallet, the crypto asset can be transferred to a blockchain wallet address provided by the recipient. The temporary blockchain wallet can be discarded and/or the on-chain resolution directory can be updated to dissolve the wallet or mark the wallet as invalid or unused. In some embodiments, the on-chain resolution directory is updated to register the blockchain wallet address provided by the recipient to the recipient's personal identifier.

In some embodiments, once the recipient takes ownership of the temporary blockchain wallet, the on-chain resolution directory is updated to reflect the new owner. In some embodiments, the on-chain resolution directory may be a conditional assignment which is made unconditional now that the recipient's identity has been verified. By updating the on-chain resolution directory, the personal identifier can be used for future crypto asset transactions. For example, with the personal identifier now registered to the newly transferred blockchain wallet, future crypto asset transfers sent to the recipient's personal identifier will resolve to the newly registered blockchain wallet address. In various embodiments, the on-chain resolution directory indexes the registered blockchain wallet address using a masked unique identifier associated with the personal identifier that maintains the privacy of the public identifier.

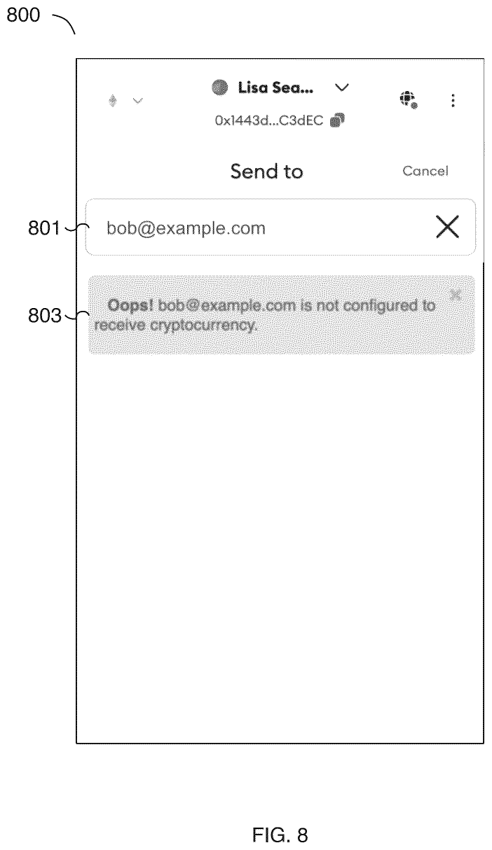

FIG. 8 is a diagram illustrating an embodiment of a user interface for transferring a crypto asset to a recipient using a personal identifier. In the example shown, user interface 800 is a user interface of a crypto wallet application for sending a crypto asset to a recipient. User interface field 801 allows the sender to specify a personal identifier of the intended recipient (bob@example.com) and user dialog 803 is a notification that the provided personal identifier does not currently resolve to a valid blockchain wallet address. In response to the failed resolution of the provided personal identifier to a valid blockchain wallet address, a temporary blockchain wallet can be generated and used to hold the crypto asset until it can be claimed by the recipient and the recipient can be assigned ownership of the newly generated blockchain wallet address. In various embodiments, on subsequent crypto asset transfers, the recipient's personal identifier will resolve to the assigned blockchain wallet address. In the example of FIG. 8, user interface 800 displays the scenario where the recipient has yet to claim ownership to a blockchain wallet using the recipient's personal identifier (bob@example.com). In some embodiments, user interface 800 is a user interface provided by crypto wallet service 111 of FIG. 1 and/or crypto wallet application 201 of FIG. 2 and accessible by a client functioning as a sender of a crypto asset such as client 101 of FIG. 1.

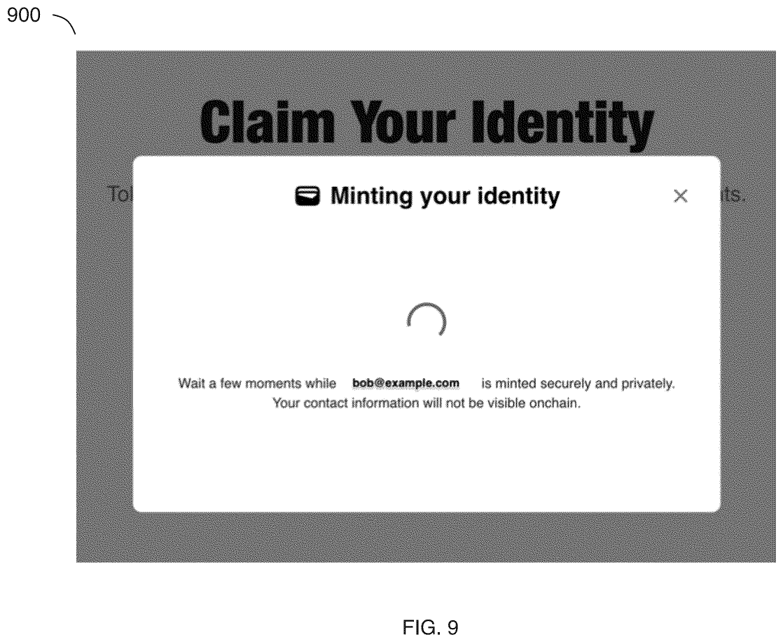

FIG. 9 is a diagram illustrating an embodiment of a user interface for claiming a crypto asset transferred to a recipient using a personal identifier. In the example shown, user interface 900 is a user interface of a crypto wallet application for receiving a crypto asset sent to the recipient via the recipient's personal identifier (bob@example.com). As shown in FIG. 9, user interface 900 provides a message that the recipient is claiming the identity associated with the recipient's email address (bob@example.com). In various embodiments, the claiming process includes updating an on-chain resolution directory that allows the personal identifier to resolve to the recipient's blockchain wallet address. Using the processes of FIGS. 3-7, the resolution can be performed on-chain using a masked unique identifier calculated from the personal identifier that does not publicly reveal the recipient's personal identifier. In some embodiments, user interface 900 is a user interface provided by crypto wallet service 111 of FIG. 1 and/or crypto wallet application 201 of FIG. 2 and accessible by a client functioning as a recipient of a crypto asset such as client 103 of FIG. 1.

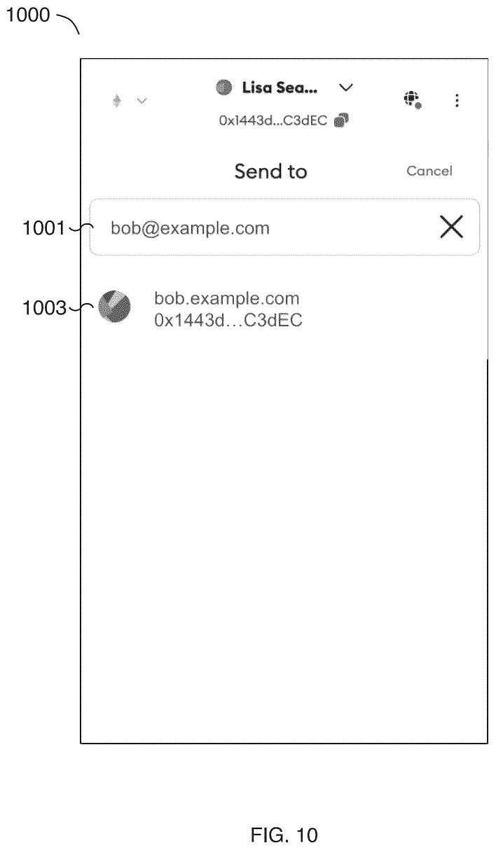

FIG. 10 is a diagram illustrating an embodiment of a user interface for transferring a crypto asset to a recipient using a personal identifier. In the example shown, user interface 1000 is a user interface of a crypto wallet application for sending a crypto asset to a recipient. User interface field 1001 allows the sender to specify a personal identifier of the intended recipient (bob@example.com) and user interface element 1003 displays the blockchain wallet address registered to the personal identifier of the provided intended recipient. In the example shown, user interface element 1003 displays the provided personal identifier (bob@example.com) along with a portion of the resolved blockchain wallet address. In various embodiments, user interface 1000 corresponds to user interface 800 of FIG. 8 when the recipient's personal identifier is successfully resolved to a blockchain wallet address. In the example of FIG. 10, the mapping of the personal identifier to the resolved blockchain wallet address is performed on-chain using an on-chain resolution directory. In some embodiments, the resolution is performed using the processes of FIGS. 3-7. As shown by the personal identifier compared to the partial blockchain wallet address, the ability to specify a recipient by a personal identifier instead of by the recipient's blockchain wallet address significantly improves the usability and functionality of the crypto wallet while also significantly removing the likelihood of introducing a user error when a blockchain wallet address is manually entered. In some embodiments, user interface 1000 is a user interface provided by crypto wallet service 111 of FIG. 1 and/or crypto wallet application 201 of FIG. 2 to a client functioning as a sender of a crypto asset such as client 101 of FIG. 1 after the recipient's personal information has been resolved by the crypto wallet to a valid blockchain wallet address.

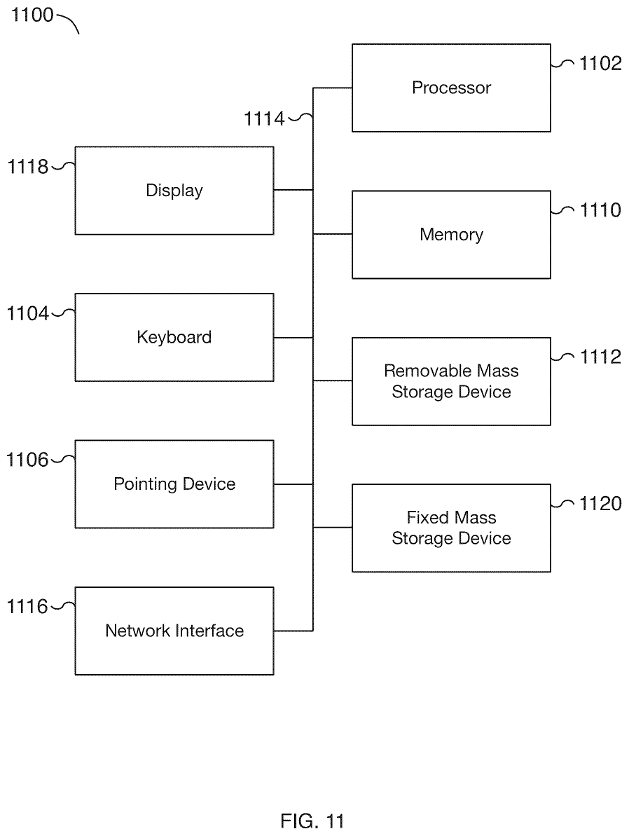

FIG. 11 is a functional diagram illustrating a programmed computer system for the on-chain resolution of contact information. As will be apparent, other computer system architectures and configurations can be utilized for supporting the on-chain resolution of contact information. Examples of computer system 1100 include clients 101 and 103 of FIG. 1, one or more computers of crypto wallet service 111 of FIG. 1, one or more computers included in blockchain 121 of FIG. 1, and/or one or more computers used to implement crypto wallet application 201 of FIG. 2. Computer system 1100, which includes various subsystems as described below, includes at least one microprocessor subsystem (also referred to as a processor or a central processing unit (CPU)) 1102. For example, processor 1102 can be implemented by a single-chip processor or by multiple processors. In some embodiments, processor 1102 is a general purpose digital processor that controls the operation of the computer system 1100. Using instructions retrieved from memory 1110, the processor 1102 controls the reception and manipulation of input data, and the output and display of data on output devices (e.g., display 1118). In various embodiments, one or more instances of computer system 1100 can be used to implement at least portions of the processes of FIGS. 3-7 and the user interface and underlying functionality associated with the diagrams of FIGS. 8-10.

Processor 1102 is coupled bi-directionally with memory 1110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1102. Also as is well known in the art, primary storage typically includes basic operating instructions, program code, data and objects used by the processor 1102 to perform its functions (e.g., programmed instructions). For example, memory 1110 can include any suitable computer-readable storage media, described below, depending on whether, for example, data access needs to be bi-directional or unidirectional. For example, processor 1102 can also directly and very rapidly retrieve and store frequently needed data in a cache memory (not shown).

A removable mass storage device 1112 provides additional data storage capacity for the computer system 1100, and is coupled either bi-directionally (read/write) or unidirectionally (read only) to processor 1102. For example, storage 1112 can also include computer-readable media such as magnetic tape, flash memory, PC-CARDS, portable mass storage devices, holographic storage devices, and other storage devices. A fixed mass storage 1120 can also, for example, provide additional data storage capacity. The most common example of mass storage 1120 is a hard disk drive. Mass storages 1112, 1120 generally store additional programming instructions, data, and the like that typically are not in active use by the processor 1102. It will be appreciated that the information retained within mass storages 1112 and 1120 can be incorporated, if needed, in standard fashion as part of memory 1110 (e.g., RAM) as virtual memory.

In addition to providing processor 1102 access to storage subsystems, bus 1114 can also be used to provide access to other subsystems and devices. As shown, these can include a display monitor 1118, a network interface 1116, a keyboard 1104, and a pointing device 1106, as well as an auxiliary input/output device interface, a sound card, speakers, and other subsystems as needed. For example, the pointing device 1106 can be a mouse, stylus, track ball, or tablet, and is useful for interacting with a graphical user interface.

The network interface 1116 allows processor 1102 to be coupled to another computer, computer network, or telecommunications network using a network connection as shown. For example, through the network interface 1116, the processor 1102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect the computer system 1100 to an external network and transfer data according to standard protocols. For example, various process embodiments disclosed herein can be executed on processor 1102, or can be performed across a network such as the Internet, intranet networks, or local area networks, in conjunction with a remote processor that shares a portion of the processing. Additional mass storage devices (not shown) can also be connected to processor 1102 through network interface 1116.

An auxiliary I/O device interface (not shown) can be used in conjunction with computer system 1100. The auxiliary I/O device interface can include general and customized interfaces that allow the processor 1102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 11 is but an example of a computer system suitable for use with the various embodiments disclosed herein. Other computer systems suitable for such use can include additional or fewer subsystems. In addition, bus 1114 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a personal identifier of a recipient of a crypto asset to be sent from a sender, wherein the personal identifier includes at least one of the following: an email address, a phone number, a driver's license number, a physical mailing address, a government assigned identifier, a school assigned identifier, or a social media account identifier; and
using data stored on a blockchain to determine whether a blockchain wallet address is associated with the personal identifier.

2. The method of claim 1, further comprising in response to a determination that the blockchain wallet address is associated with the personal identifier, providing the blockchain wallet address.

3. The method of claim 2, further comprising transferring the crypto asset to the provided blockchain wallet address.

4. The method of claim 1, further comprising in response to a determination that no blockchain wallet address is associated with the personal identifier, generating a new temporary blockchain wallet for the personal identifier.

5. The method of claim 4, further comprising transferring the crypto asset to the new temporary blockchain wallet.

6. The method of claim 5, further comprising notifying the recipient of an option to claim the new temporary blockchain wallet or the crypto asset.

7. The method of claim 5, further comprising verifying an identity of the recipient.

8. The method of claim 7, wherein verifying the identity of the recipient includes confirming ownership or control of the personal identifier of the recipient.

9. The method of claim 7, further comprising in response to a successful verification of the identity of the recipient, assigning ownership of the new temporary blockchain wallet to the recipient.

10. The method of claim 1, further comprising determining a unique identifier for the personal identifier, wherein the data stored on the blockchain maps the unique identifier to the blockchain wallet address.

11. The method of claim 10, wherein determining the unique identifier includes applying a one-way hash function on at least a portion of the personal identifier of the recipient.

12. A system, comprising:
one or more processors configured to:
receive a personal identifier of a recipient of a crypto asset to be sent from a sender, wherein the personal identifier includes at least one of the following: an email address, a phone number, a driver's license number, a physical mailing address, a government assigned identifier, a school assigned identifier, or a social media account identifier; and
determine whether a blockchain wallet address is associated with the personal identifier using data stored on a blockchain; and
a memory coupled to the one or more processors and configured to provide the one or more processors with instructions.

13. The system of claim 12, wherein the one or more processors are further configured to: in response to a determination that the blockchain wallet address is associated with the personal identifier, provide the blockchain wallet address.

14. The system of claim 13, wherein the one or more processors are further configured to: transfer the crypto asset to the provided blockchain wallet address.

15. The system of claim 12, wherein the one or more processors are further configured to: in response to a determination that no blockchain wallet address is associated with the personal identifier, generate a new temporary blockchain wallet for the personal identifier.

16. The system of claim 15, wherein the one or more processors are further configured to: transfer the crypto asset to the new temporary blockchain wallet.

17. The system of claim 16, wherein the one or more processors are further configured to: notify the recipient of an option to claim the new temporary blockchain wallet or the crypto asset.

18. The system of claim 16, wherein the one or more processors are further configured to: verify an identity of the recipient.

19. The system of claim 18, wherein the one or more processors are further configured to: in response to a successful verification of the identity of the recipient, assign ownership of the new temporary blockchain wallet to the recipient.

20. A computer program product embodied in a non-transitory computer readable medium and comprising computer instructions for:
receiving a personal identifier of a recipient of a crypto asset to be sent from a sender, wherein the personal identifier includes at least one of the following: an email address, a phone number, a driver's license number, a social security number, a government assigned identifier, a school assigned identifier, or a social media account identifier; and
using data stored on a blockchain to determine whether a blockchain wallet address is associated with the personal identifier.
